(19) United States
(12) Patent Application Publication
(10) Pub. No.: US 2024/0128013 A1
(43) Pub. Date: Apr. 18, 2024

(54) INDUCTOR COMPONENT

(71) Applicant: Murata Manufacturing Co., Ltd., Kyoto-fu (JP)

(72) Inventor: Ryuichiro TOMINAGA, Nagaokakyo-shi (JP)

(73) Assignee: Murata Manufacturing Co., Ltd., Kyoto-fu (JP)

(21) Appl. No.: 18/451,717

(22) Filed: Aug. 17, 2023

(30) Foreign Application Priority Data
Oct. 14, 2022 (JP) 2022-165748

(51) Int. Cl. H01F 27/32

(52) U.S. Cl. CPC H01F 27/323; H01F 27/34

(57) ABSTRACT

An inductor component includes: a first internal conductor; a second internal conductor; an insulating interlayer disposed between the first internal conductor and the second internal conductor and having a first main surface on the first internal conductor side, a second main surface on the second internal conductor side, and a via extending therethrough between the first main surface and the second main surface; and a via conductor inserted through the via and electrically connecting the first internal conductor and the second internal conductor. In a first section including a central axis of the via conductor, the via conductor has a wedge portion interposed between the insulating interlayer and the first internal conductor in a direction parallel to the central axis.

### CROSS-REFERENCE TO RELATED APPLICATION

This application claims benefit of priority to Japanese Patent Application No. 2022-165748, filed Oct. 14, 2022, the entire content of which is incorporated herein by reference.

### BACKGROUND

### Technical Field

The present disclosure relates to an inductor component.

### Background Art

Japanese Unexamined Patent Application Publication No. 2019-212692 describes an example of electronic components. Existing electronic components each have, for example, two internal conductors, an insulating interlayer disposed between the two internal conductors and having a via, and a via conductor inserted through the via. The via conductor electrically connects the two internal conductors. The via has a tapered shape such that the diameter thereof decreases in the depth direction.

### SUMMARY

However, in existing electronic components, the shear strength between the via conductor and the internal conductors is not sufficient, and connection reliability may possibly decrease.

Accordingly, the present disclosure provides an inductor component having high shear strength between a via conductor and internal conductors.

An inductor component according to an aspect of the present disclosure includes a first internal conductor; a second internal conductor; an insulating interlayer disposed between the first internal conductor and the second internal conductor and having a first main surface on the first internal conductor side, a second main surface on the second internal conductor side, and a via extending therethrough between the first main surface and the second main surface; and a via conductor inserted through the via and electrically connecting the first internal conductor and the second internal conductor. In a first section including a central axis of the via conductor, the via conductor has a wedge portion interposed between the insulating interlayer and the first internal conductor in a direction parallel to the central axis.

With the aspect, it is possible to increase the shear strength between the via conductor and the internal conductors.

With the inductor component according to an aspect of the present disclosure, the shear strength between the via conductor and the internal conductors is increased.

### BRIEF DESCRIPTION OF THE DRAWINGS

FIG. 1 is a see-through plan view of an inductor component according to a first embodiment;

FIG. 2 is a sectional view taken along line II-II of FIG. 1;

FIG. 3 is an enlarged view of a region A of FIG. 2;

FIG. 4A is a schematic sectional view illustrating a method of manufacturing the inductor component;

FIG. 4B is a schematic sectional view illustrating the method of manufacturing the inductor component;

FIG. 4C is a schematic sectional view illustrating the method of manufacturing the inductor component;

FIG. 4D is a schematic sectional view illustrating the method of manufacturing the inductor component;

FIG. 4E is a schematic sectional view illustrating the method of manufacturing the inductor component;

FIG. 4F is a schematic sectional view illustrating the method of manufacturing the inductor component;

FIG. 4G is a schematic sectional view illustrating the method of manufacturing the inductor component;

FIG. 4H is a schematic sectional view illustrating the method of manufacturing the inductor component;

FIG. 4I is a schematic sectional view illustrating the method of manufacturing the inductor component;

FIG. 4J is a schematic sectional view illustrating the method of manufacturing the inductor component;

FIG. 4K is a schematic sectional view illustrating the method of manufacturing the inductor component;

FIG. 5 is a schematic sectional view of an inductor component according to a second embodiment;

FIG. 6 is a schematic sectional view of an inductor component according to a third embodiment; and

FIG. 7 is a schematic sectional view of an inductor component according to a fourth embodiment.

### DETAILED DESCRIPTION

Hereafter, an inductor component according to an aspect of the present disclosure will be described in detail with reference to embodiments thereof illustrated in the drawings. Some of the drawings are schematic and do not necessarily reflect actual dimensions and/or proportions.

### First Embodiment

Configuration

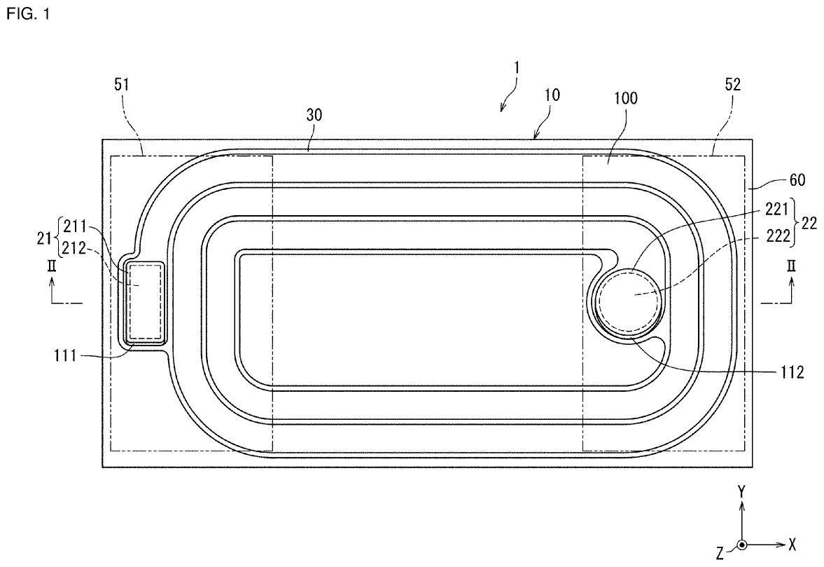

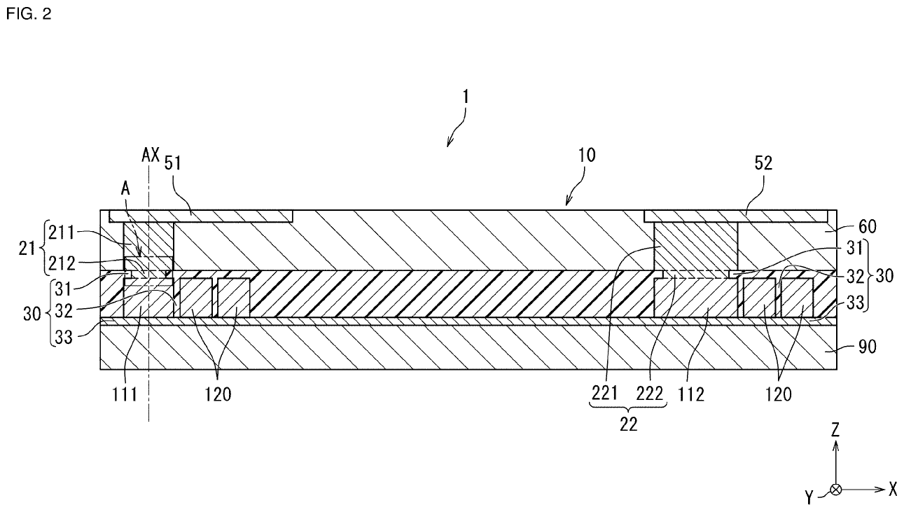

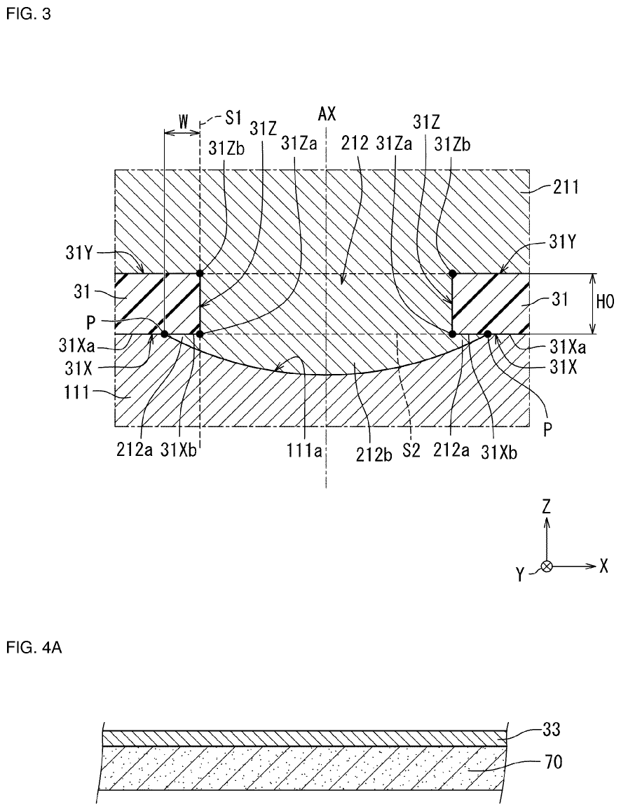

FIG. 1 is a see-through plan view of an inductor component 1 according to an embodiment. FIG. 2 is a sectional view taken along line II-II of FIG. 1. FIG. 2 illustrates an XZ section including a central axis AX of a via conductor. The XZ section is an example of a first section including the central axis AX. For convenience of illustration, FIG. 2 does not illustrate a constricted portion and a protruding portion of the via conductor described below, a recessed portion of a first pad portion, and a seed layer. These are illustrated in FIG. 3 and other figures.

In the figures, the Z direction is defined as the thickness direction of the inductor component 1. In a plane perpendicular to the Z direction of the inductor component 1, the X direction is defined as a direction that is the longitudinal direction of the inductor component 1 and in which a first external terminal 51 and a second external terminal 52 are arranged. The Y direction is defined as a direction perpendicular to the longitudinal direction. The XZ-sectional view is obtained by cutting the inductor component 1 along a plane that is formed by a straight line extending in the X direction and a straight line extending in the Z direction and that includes the central axis AX of the via conductor.

The inductor component 1 is a component that has, for example, a generally rectangular parallelepiped shape and that is to be installed in an electronic device such as a personal computer, a DVD player, a digital camera, a television set, a mobile phone, or automotive electronics. Note that the shape of the inductor component 1 is not limited, and may be a cylindrical shape, a prismatic shape, a frustum shape, or a pyramidal shape.

As illustrated in FIGS. 1 and 2, the inductor component 1 has an element body 10, an inductor conductor 100, an insulating layer 30, a first vertical conductor 21, a second vertical conductor 22, the first external terminal 51, and the second external terminal 52. In FIG. 1, for convenience of illustration, the external terminals are represented by two-dot chain lines. In FIG. 1, the element body 10 and a coating film 60 are illustrated to be transparent for ease of understanding the structure. However, these may be translucent or opaque.

The element body 10 has an insulating substrate 90, the insulating layer 30 disposed on the insulating substrate 90, and the coating film 60 disposed on the insulating layer 30. The insulating substrate 90, the insulating layer 30, and the coating film 60 are stacked in the central axis AX direction so that the inductor conductor 100 is interposed. That is, the inductor conductor 100 is provided in the element body 10. A substrate 70 described below may be disposed between the insulating substrate 90 and the insulating layer 30.

Hereafter, an upward direction refers to the central axis AX direction (the Z direction) from the insulating substrate 90 toward the coating film 60. An upper surface of an element refers to a surface of the element facing in the upward direction. A downward direction refers to the central axis AX direction from the coating film 60 toward the insulating substrate 90. A lower surface of an element refers to a surface of the element facing in the downward direction.

A width direction refers to a direction perpendicular to the central axis AX direction, and is also referred to as the X direction. The width of an element refers to the length of the element in the width direction. A height direction is a direction parallel to the central axis AX direction, and is also referred to as the Z direction as described above. The height of an element refers to the length of the element in the height direction.

An inductor conductor means a conductor that is shaped like a curve (two-dimensional curve) extending in a plane. The curve may have more than one turn, may have less than one turn, or may have a straight line in a part thereof.

The inductor conductor 100 is provided on or above the upper surface of the insulating substrate 90 and extends in a direction parallel to the upper surface of the insulating substrate 90. The inductor conductor 100 is wound spirally around the axis of the inductor conductor 100 on or above the upper surface of the insulating substrate 90. The inductor conductor 100 has a spiral shape having more than one turn. As seen from above, the inductor conductor 100 is spirally wound in the clockwise direction from the outer peripheral end toward the inner peripheral end. The shape of the inductor conductor 100 may be a curve having less than one turn or may have a straight line in a part thereof.

The inductor conductor 100 has a thickness of, for example, 40 μm or greater and 120 μm or less (i.e., from 40 μm to 120 μm). To be specific, the inductor conductor 100 has a thickness of 45 μm, a conductor width of 50 μm, and a conductor spacing of 10 μm. The conductor spacing may be 3 μm or greater and 20 μm or less (i.e., from 3 μm to 20 μm).

The inductor conductor 100 has a spiral portion 120, a first pad portion 111, and a second pad portion 112. The first pad portion 111 is connected to the first vertical conductor 21, and the second pad portion 112 is connected to the second vertical conductor 22. The spiral portion 120 extends, with the first pad portion 111 as the outer peripheral end and the second pad portion 112 as the inner peripheral end, from the first pad portion 111 and the second pad portion 112 in directions parallel to the upper surface of the insulating substrate 90 and is wound spirally.

The insulating substrate 90 supports the inductor conductor 100. The insulating substrate 90 is made of an insulating material that does not include a magnetic substance and includes, for example, any of an epoxy resin, a polyimide resin, a phenolic resin, an acrylic resin, and a vinyl ether resin.

The coating film 60 protects the inductor conductor 100. The coating film 60 is also made of the aforementioned insulating material that does not include a magnetic substance. The coating film 60 is formed of, for example, a solder resist.

The insulating layer 30 covers at least a part of the inductor conductor 100. The insulating layer 30 has an insulating interlayer 31, a resin wall 32, and an insulating underlayer 33. The insulating interlayer 31 covers the upper surface of the inductor conductor 100, the resin wall 32 covers the side surface of the inductor conductor 100, and the insulating underlayer 33 covers the lower surface of the inductor conductor 100. To be specific, the resin wall 32 is provided on the same plane as the inductor conductor 100 and is provided between turns of the inductor conductor 100 and on the radially outer side and radially inner side of the inductor conductor 100. The insulating interlayer 31 covers the upper surface of the inductor conductor 100 and has vias at positions corresponding to the first and second pad portions 111 and 112 of the inductor conductor 100. The insulating layer 30 is composed of two insulating interlayers 31, the resin wall 32, and the insulating underlayer 33. However, the insulating layer 30 may be composed of one insulating layer, two insulating layers, or four or more insulating layers.

The insulating layer 30 is formed of a photosensitive permanent photoresist. A photosensitive permanent photoresist is a photoresist that is not removed after having been processed. To be specific, the insulating layer 30 is made of the aforementioned insulating material that does not include a magnetic substance. Thus, insulation reliability is improved. The insulating underlayer 33 may include a filler of a nonmagnetic substance such as silica. The thickness of the insulating underlayer 33 is, for example, 10 μm or less.

The first vertical conductor 21 and the second vertical conductor 22 extend in the central axis AX direction from the inductor conductor 100 and extend through the element body 10. The first vertical conductor 21 has a first via conductor 212 and a first columnar conductor 211. The first via conductor 212 extends upward from the upper surface of the first pad portion 111 of the inductor conductor 100 and extends through the inside of the insulating interlayer 31. The first columnar conductor 211 extends upward from the first via conductor 212 and extends through the inside of the coating film 60. The second vertical conductor 22 includes a second via conductor 222 and a second columnar conductor 221. The second via conductor 222 extends upward from the upper surface of the second pad portion 112 of the inductor conductor 100 and extends through the inside of the insulating interlayer 31. The second columnar conductor 221 extends upward from the second via conductor 222 and extends through the inside of the coating film 60.

One of the inductor conductor 100 and the first columnar conductor 211 corresponds to an example of “first internal conductor” described in the claims. The other of the inductor conductor 100 and the first columnar conductor 211 corresponds to an example of “second internal conductor” described in the claims. In this case, the first via conductor 212 corresponds to an example of “via conductor” described in the claims.

One of the inductor conductor 100 and the second columnar conductor 221 corresponds to an example of “first internal conductor” described in the claims. The other of the inductor conductor 100 and the second columnar conductor 221 corresponds to an example of “second internal conductor” described in the claims. In this case, the second via conductor 222 corresponds to an example of “via conductor” described in the claims.

The inductor conductor 100 is made of a conductive material that is, for example, a metal material having low electric resistance such as Au, Pt, Pd, Ag, Cu, Al, Co, Cr, Zn, Ni, Ti, W, Fe, Sn, In, or an alloy including any of these. Thus, it is possible to reduce the direct-current resistance of the inductor component 1. The first vertical conductor 21 and the second vertical conductor 22 are each made of a material similar to that of the inductor conductor 100. In particular, the conductive material may be Cu, Ag, Au, Fe, or an alloy including any of these.

The first external terminal 51 is provided on the upper surface of the coating film 60 and covers an end surface of the first columnar conductor 211 exposed from the upper surface. Thus, the first external terminal 51 is electrically connected to the first pad portion 111 of the inductor conductor 100. The second external terminal 52 is provided on the upper surface of the coating film 60 and covers an end surface of the second columnar conductor 221 exposed from the upper surface. Thus, the second external terminal 52 is electrically connected to the second pad portion 112 of the inductor conductor 100.

The first external terminal 51 and the second external terminal 52 are each made of a conductive material. The first external terminal 51 and the second external terminal 52 each have, for example, a three-layer structure in which a Cu layer having low electric resistance and high stress resistance, a Ni layer having high corrosion resistance, and an Au layer having high solder wettability and high reliability are stacked from inside toward outside in this order.

FIG. 3 is an enlarged view of a region A of FIG. 2. FIG. 3 illustrates a part of the first section including the central axis A. As illustrated in FIG. 3, the first via conductor 212 has a wedge portion 212a interposed between the insulating interlayer 31 and the first pad portion 111 in a direction parallel to the central axis AX. When a first reference line S1 is defined as a straight line including a first open end 31Za of a via 31Z and parallel to the central axis AX, the wedge portion 212a is located on a side opposite to the central axis AX with respect to the first reference line S1. Thus, the wedge portion 212a produces an anchor effect on the insulating interlayer 31 and the first pad portion 111, and therefore the shear strength between the first via conductor 212 and the first pad portion 111 is improved and connection reliability is increased.

The insulating interlayer 31 has a first main surface 31X on the first pad portion 111 side, a second main surface 31Y on the first columnar conductor 211 side, and the via 31Z extending therethrough between the first main surface 31X and the second main surface 31Y. The first main surface 31X includes a first portion 31Xa in contact with the first pad portion 111. The via 31Z has a flat inner surface. Here, the flat inner surface refers to a linear portion of the inner surface of the via 31Z in the first section. The via 31Z includes the first open end 31Za on the first pad portion 111 side and a second open end 31Zb on the first columnar conductor 211 side. The flat inner surface of the via 31Z is a region that connects the first open end 31Za and the second open end 31Zb. In other words, the first open end 31Za is located at an end of the flat inner surface on the first pad portion 111 side, and the second open end 31Zb is located at an end of the flat inner surface on the first columnar conductor 211 side. The inner surface of the via 31Z extends in a direction along the central axis AX.

The first main surface 31X further has a connection portion 31Xb between the first open end 31Za and an end portion of the first portion 31Xa on the first open end 31Za side (the end portion being the intersection point of the first pad portion 111 and the insulating interlayer 31, hereafter referred to as an intersection point P). The intersection point P corresponds to an example of “intersection point of the first internal conductor and the insulating interlayer” described in the claims (claim 2). It can be said that the connection portion 31Xb is a portion of the first main surface 31X that is not in contact with the first pad portion 111. The connection portion 31Xb is located at an end portion of the first main surface 31X on the via 31Z side. To be more specific, the wedge portion 212a is disposed between the connection portion 31Xb and the first pad portion 111.

A second reference line S2 is defined as a straight line including the first portion 31Xa. In FIG. 3, the first reference line S1 and the second reference line S2 are represented by dotted lines.

In a case where the first via conductor 212 does not have the wedge portion 212a as in existing technologies, when an external force in the width direction is applied to the inductor component 1, the stress tends to concentrate on the boundary portion between the first via conductor 212 and the first pad portion 111 (typically, on the second reference line S2). The first pad portion 111 and the first via conductor 212, which are usually formed in different steps, structurally tend to peel apart at the boundary portion. When a stress concentrates on the boundary portion, which intrinsically tends to peel apart, disconnection occurs easily. By disposing the wedge portion 212a so as to be interposed between the insulating interlayer 31 and the first pad portion 111 in the direction parallel to the central axis AX, the area of the boundary portion is increased, and therefore concentration of stress is reduced. Thus, disconnection becomes unlikely to occur, and the connection reliability of the inductor component 1 is improved further.

The distance between the connection portion 31Xb and the first pad portion 111 increases toward the central axis AX. Thus, while the first via conductor 212 is formed by using a plating method, a plating solution can easily flow into a gap between the connection portion 31Xb and the first pad portion 111, and therefore generation of a void in the wedge portion 212a is suppressed. A void might cause breakage of a plating layer, which is the first via conductor 212 here.

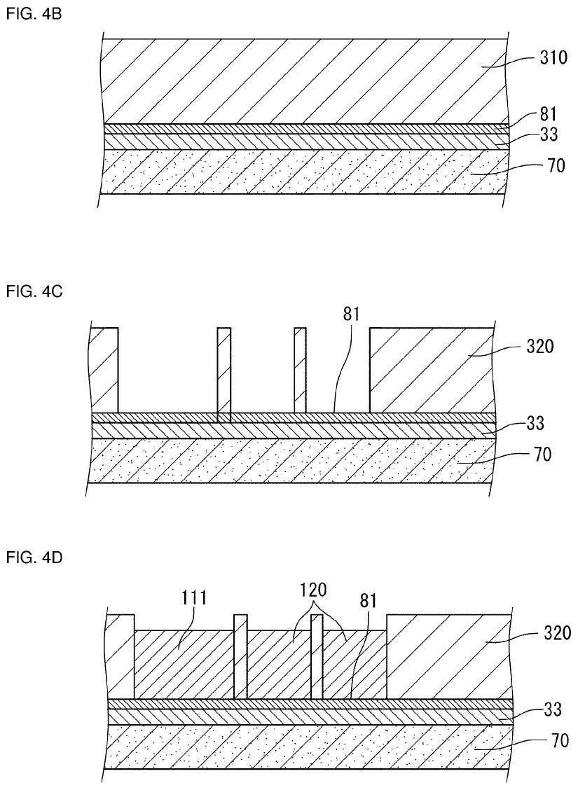

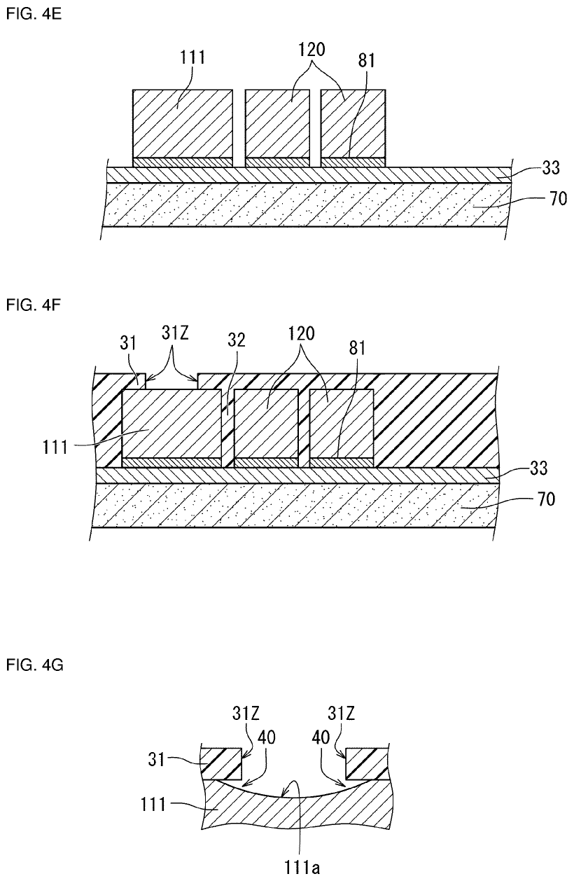

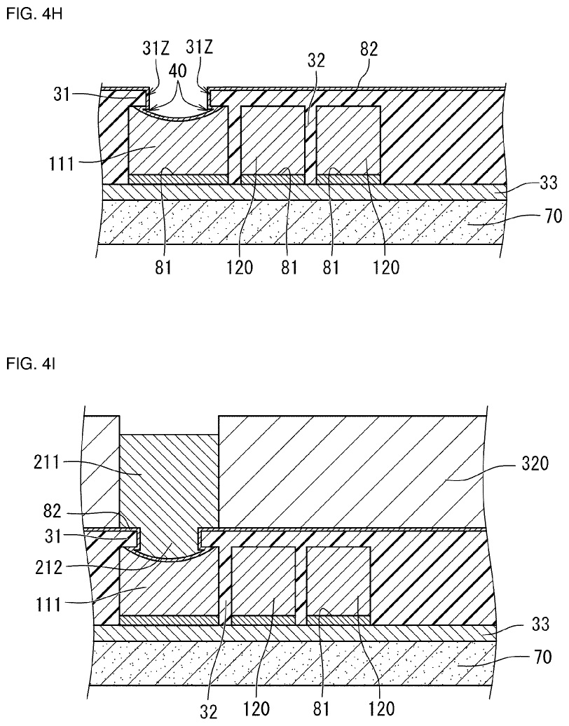

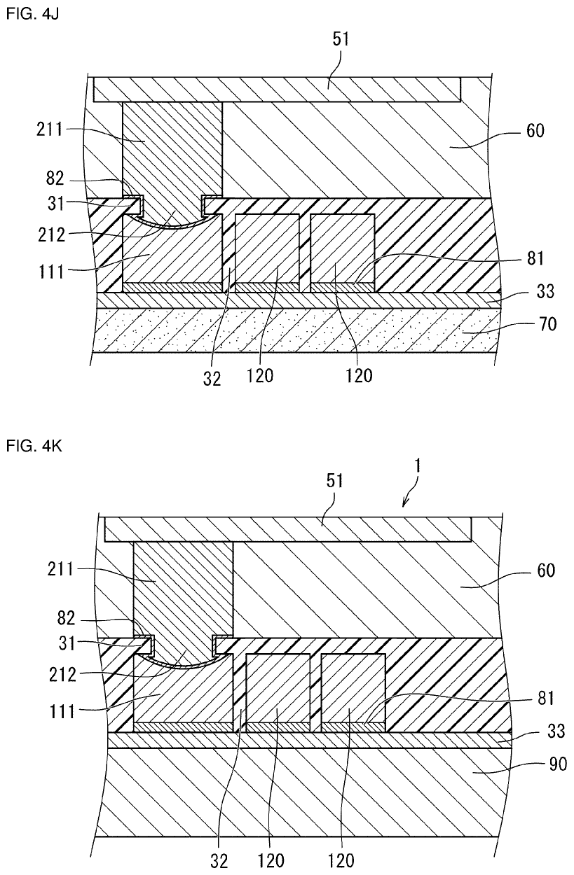

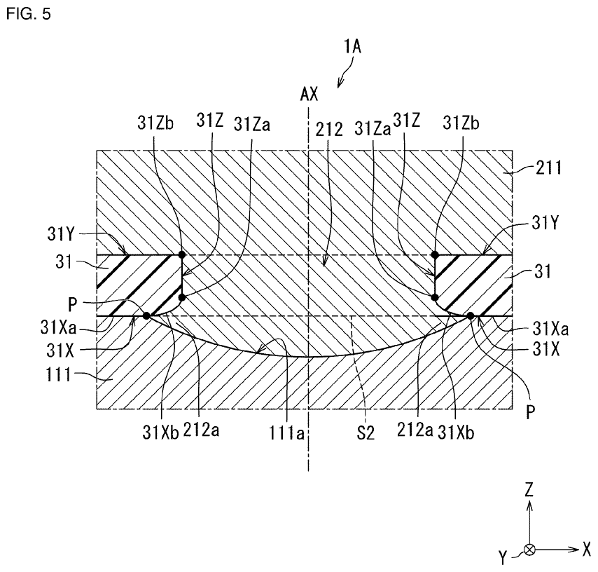

The distance from the intersection point P of the first pad portion 111 and the insulating interlayer 31 to the first open end 31Za in the direction perpendicular to the central axis AX (hereafter, referred to as the width W of the wedge portion 212a) may be 3 μm or greater and 10 μm or less (i.e., from 3 μm to 10 μm). When the width W of the wedge portion 212a is 3 μm or greater, the aforementioned anchor effect can be obtained easily. When the width W of the wedge portion 212a is 10 μm or less, a short circuit between the wedge portion 212a and an adjacent conductor does not occur easily. Moreover, while the wedge portion 212a is formed by using a plating method, a seed layer 82 can be easily formed in a gap 40 between the first pad portion 111 and the insulating interlayer 31 (see FIG. 4H), and a failure such as generation of a void in the wedge portion 212a can be easily suppressed.

Recessed Portion, Protruding Portion

As illustrated in FIG. 3, the first pad portion 111 has a recessed portion 111a recessed from the second reference line S2. The first via conductor 212 has a protruding portion 212b protruding into the recessed portion 111a. Thus, the contact area between the first pad portion 111 and the first via conductor 212 increases, and therefore shear strength is improved further.

Moreover, due to the recessed portion 111a, the boundary portion between the first via conductor 212 and the first pad portion 111 is displaced from the second reference line S2 in the downward direction. That is, the point of stress concentration due to an external force in the width direction does not coincide with the aforementioned boundary portion, and therefore disconnection at the boundary portion also becomes unlikely to occur.

FIG. 2 illustrates sections of two via conductors in the section including the central axis AX. However, it is sufficient that at least one of the two via conductors satisfy the aforementioned configurations illustrated in FIG. 3. The aforementioned configurations illustrated in FIG. 3 may be satisfied, but need not be satisfied, in another section including the central axis AX. It is sufficient that least one of a plurality of via conductors included in the inductor component 1 satisfy the aforementioned configurations illustrated in FIG. 3.

Manufacturing Method

Next, referring to FIGS. 4A to 4K, a method of manufacturing the inductor component 1 will be described. FIGS. 4A to 4K are each a view corresponding to the first pad portion 111 of the inductor conductor 100 and the first vertical conductor 21 of FIG. 2.

As illustrated in FIG. 4A, the insulating underlayer 33 that does not include a magnetic substance is formed on the substrate 70. For example, the substrate 70 is made of sintered ferrite and has a flat plate-like shape.

The substrate 70, which has a flat plate-like shape, serves as a base in the process of manufacturing the inductor component 1. The substrate 70 is made of, for example, a sintered compact of a magnetic substrate made of ferrite including NiZn, MnZn, or the like, or a nonmagnetic substrate made of alumina or glass. The substrate 70 has a thickness of, for example, 5 μm or greater and 100 μm or less (i.e., from 5 μm to 100 μm).

The insulating underlayer 33 is made of, for example, a polyimide resin or an inorganic material that does not include a magnetic substance. The insulating underlayer 33 is formed by coating the substrate 70 with a polyimide resin by printing, application, or the like, or by performing a dry process such as vapor deposition, sputtering, or CVD on the substrate 70.

As illustrated in FIG. 4B, a seed layer 81 and a resist film 310 are formed on the insulating underlayer 33. To be specific, the material of the seed layer 81 is sputtered to adhere to the upper surface of the insulating underlayer 33. Next, the resist film 310 is formed on the seed layer 81. The seed layer 81 is made of a metal material having low electric resistance similar to any of those listed above as the material of the inductor conductor 100. The resist film 310 is formed from a photosensitive resist.

As illustrated in FIG. 4C, a part of the resist film 310 is removed. To be specific, a photolithographic method is used. That is, exposure to light is performed by using a photomask that has openings corresponding to portions other than the first pad portion 111 and the spiral portion 120. Thus, the resist film 310 at the portions corresponding to the first pad portion 111 and the spiral portion 120 is not exposed to light and remains uncured. Next, the uncured portions are removed by performing development. In the development, for example, an organic solvent such as propylene glycol methyl ether acetate (PGMEA) and an alkaline development liquid such as tetramethylammonium hydroxide (TMAH) are used.

As illustrated in FIG. 4D, the first pad portion 111 and the spiral portion 120 are formed on the seed layer 81. To be specific, plating is grown on the seed layer 81 by electrolytic plating. Thus, the first pad portion 111 and the spiral portion 120 are formed between residues of the resist film 310.

As illustrated in FIG. 4E, the resist film 310 and portions of the seed layer 81 that are located below the lower surface of the resist film 310 are removed. These are removed by, for example, performing an etching process.

As illustrated in FIG. 4F, the insulating interlayer 31, which covers the spiral portion 120 and has the via 31Z that exposes the upper surface of the first pad portion 111, and the resin wall 32, which covers the side surface of the inductor conductor 100, are placed. A part of the first pad portion 111 is exposed from the via 31Z. A method for forming the via 31Z, which is not particularly limited, may be laser irradiation, or may be a photolithographic method.

FIG. 4G is an enlarged view illustrating a region surrounding the via 31Z formed in the insulating interlayer 31. As illustrated in FIG. 4G, the gap 40 is formed in the first pad portion 111. Plating enters into the gap 40, and thus the wedge portion 212a is formed. At this time, by performing etching isotropically, the recessed portion 111a is formed, together with the gap 40, in a portion of the first pad portion 111 exposed from the insulating interlayer 31.

The etching method, which is not particularly limited as long as isotropic etching is possible, may be wet etching using acid, or may be dry etching. The width W of the wedge portion 212a is controlled by controlling the etching amount of the first pad portion 111. It is possible to adjust the etching amount by appropriately adjusting the time and/or temperature of the etching process. In a case where wet etching is performed at 25° C. by using a processing agent including H₂O₂ at 5% concentration and H₃PO₄ at 10% concentration, it is possible to form the wedge portion 212a having a width W of about 3 μm in a processing time of 30 seconds, and it is possible to form the wedge portion 212a having a width W of about 10 μm in a processing time of 240 seconds. It is possible to increase the width W of the wedge portion 212a by increasing the concentration of acid in the processing agent or by increasing the processing time.

In existing technologies, an etching process performed after forming the insulating interlayer 31 is performed for the purpose of removing residues, oxide films, and the like, and is not performed for the purpose of etching the first pad portion 111. Therefore, usually, the gap 40 is not formed. In the present embodiment, the gap 40 is intentionally formed to enable formation of the wedge portion 212a, so that the shear strength between the first pad portion 111 and the first via conductor 212 is improved.

As illustrated in FIG. 4H, the seed layer 82 is formed by sputtering on the inner surface of the via 31Z, on the exposed portion of the upper surface of the first pad portion 111, and on the upper surface of the insulating interlayer 31 and the resin wall 32. The seed layer 82 is also made of a metal material having low electric resistance similar to any of those listed above as the material of the inductor conductor 100.

The thickness of the seed layer 82 is not particularly limited as long as the seed layer 82 can share electric charges and function as a seed layer for electrolytic plating, and may be, for example, 2 μm or less. In order to increase the closeness of contact between the insulating interlayer 31 and the seed layer 82, a close-contact layer may be formed between the insulating interlayer 31 and the seed layer 82. The material of the close-contact layer is not particularly limited as long as the close-contact layer does not affect forming of the inductor conductor, and may be, for example, Ti.

As illustrated in FIG. 4I, the first via conductor 212 and the first columnar conductor 211 are formed in a portion corresponding to the exposed portion of the upper surface of the first pad portion 111. To be specific, a resist film 320 is formed on the seed layer 82, and a cavity is formed at a position in the resist film 320 corresponding to the first via conductor 212. Plating is grown on the seed layer 82 by performing electrolytic plating to form a plating layer in the cavity. Thus, the first via conductor 212 and the first columnar conductor 211 are formed in the cavity. The first via conductor 212 and the first columnar conductor 211 may be formed by using an electrolytic plating method, a sputtering method, a vapor deposition method, or an application method.

As illustrated in FIG. 4J, the resist film 320 is peeled off, and the exposed seed layer 82 is removed. Next, the coating film 60 is formed on the insulating interlayer 31, and the first external terminal 51 is formed on the upper surface of the first columnar conductor 211.

As illustrated in FIG. 4K, the substrate 70 is removed, and the insulating substrate 90 is placed on the lower surface of the insulating underlayer 33. Subsequently, dicing is performed by using a dicer or the like to manufacture the inductor components 1.

### Second Embodiment

Configuration

FIG. 5 is a sectional view of an inductor component according to a second embodiment. FIG. 5 is a sectional view corresponding to FIG. 3. The second embodiment differs from the first embodiment in the shape of an end portion of the insulating interlayer 31. The difference in configuration will be described below. The other elements of the second embodiment each have the same configuration as that of the first embodiment, and such elements will be denoted by the same numerals as in the first embodiment and descriptions thereof will be omitted.

As illustrated in FIG. 5, in an inductor component 1A according to the second embodiment, the connection portion 31Xb of the insulating interlayer 31 is a convexly curved surface. In other words, the contact portion between the wedge portion 212a and the connection portion 31Xb is a concavely curved surface. A stress that is generated when an external force in the width direction is applied to the inductor component 1A tends to concentrate on an end portion of the boundary portion between the first via conductor 212 and the first pad portion 111. However, because the end portion of the boundary portion is not an edge line but a curved surface, concentration of the stress is reduced, and disconnection becomes more likely to be suppressed. Only a part of the connection portion 31Xb may be a convexly curved surface.

Manufacturing Method

The inductor component 1A can be manufactured by using a method that is the same as the manufacturing method of the first embodiment illustrated in FIGS. 4A to 4K. However, in the steps illustrated in FIGS. 4F and 4G, the via 31Z is formed by using a lithographic method using a photomask, and, in addition, during exposure to light, the irradiation intensity on a portion corresponding to a region surrounding the via 31Z is reduced. Thus, in the portion corresponding to the region surrounding the via 31Z, the degree of curing in the thickness direction of the photosensitive insulation film decreases. Subsequently, the via 31Z is formed in the insulating interlayer 31 by performing development, a part, on the lower surface side, of the end portion of the insulating interlayer 31 on the via 31Z side is removed, and the connection portion 31Xb of the insulating interlayer 31 becomes a convexly curved surface.

### Third Embodiment

Configuration

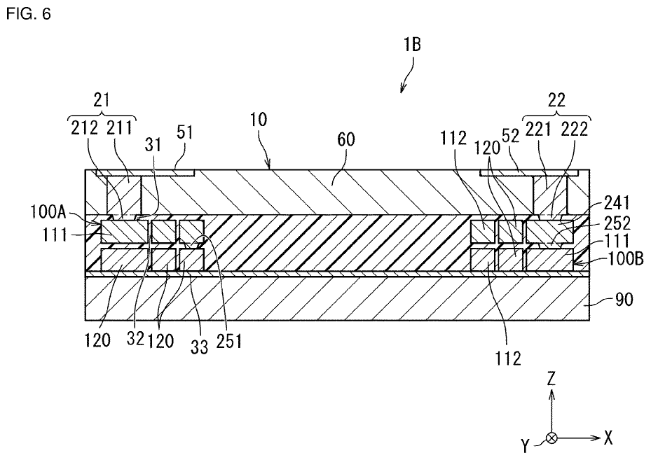

FIG. 6 is a schematic sectional view of an inductor component according to a third embodiment. FIG. 6 is a sectional view corresponding to FIG. 2. The third embodiment differs from the first embodiment in the configuration of the inductor conductor. The difference in configuration will be described below. The other elements of the third embodiment each have the same configuration as that of the first embodiment, and such elements will be denoted by the same numerals as in the first embodiment and descriptions thereof will be omitted.

As illustrated in FIG. 6, in an inductor component 1B according to the third embodiment, first and second inductor conductors 100A and 100B in two layers are stacked in the Z direction. The first inductor conductor 100A is disposed above the second inductor conductor 100B. The first and second inductor conductors 100A and 100B are connected in series.

The inductance of the inductor component 1B can be increased by increasing the number of turns, because the first inductor conductor 100A and the second inductor conductor 100B are connected in series. Moreover, because the first and second inductor conductors 100A and 100B are stacked in the normal direction, the area per turn of the inductor component 1B as seen from the Z direction, that is, the mounting area can be reduced, and reduction in size of the inductor component 1B can be realized.

The first and second inductor conductors 100A and 100B are provided on or above the upper surface of the insulating substrate 90 and extend in a direction parallel to the upper surface of the insulating substrate 90. The first and second inductor conductors 100A and 100B are each wound spirally around the axis thereof on or above the upper surface of the insulating substrate 90. The first and second inductor conductors 100A and 100B each have a spiral shape having more than one turn. The first and second inductor conductors 100A and 100B each have a configuration similar to that of the inductor conductor 100 in the first embodiment. The shape of each of the first and second inductor conductors 100A and 100B may be a curve having less than one turn, or may have a straight line in a part thereof.

The first pad portion 111, which is the outer peripheral end of the first inductor conductor 100A, is connected to the first external terminal 51 through the first vertical conductor 21. The second pad portion 112, which is the inner peripheral end of the first inductor conductor 100A, and the second pad portion 112, which is the inner peripheral end of the second inductor conductor 100B, are connected through a first interlayer via conductor 251. The first pad portion 111, which is the outer peripheral end of the second inductor conductor 100B, is connected to the second external terminal 52 through a second interlayer via conductor 252, an extended conductor 241, and the second vertical conductor 22. With the above configuration, the first inductor conductor 100A and the second inductor conductor 100B are connected in series, and are electrically connected to the first external terminal 51 and the second external terminal 52.

The extended conductor 241 is provided in the same layer as the first inductor conductor 100A. The extended conductor 241 is not directly connected to the first inductor conductor 100A. The extended conductor 241 is a conductor that extends the first pad portion 111 to the second vertical conductor 22. It is possible to provide the element body 10 with sufficient strength by making the width of the extended conductor 241 in the XZ-section larger than that of the second vertical conductor 22 (the second columnar conductor 221 and the second via conductor 222).

One of the first inductor conductor 100A and the first columnar conductor 211 corresponds to an example of “first internal conductor” described in the claims. The other of the first inductor conductor 100A and the first columnar conductor 211 corresponds to an example of “second internal conductor” described in the claims. In this case, the first via conductor 212 corresponds to an example of “via conductor” described in the claims.

One of the extended conductor 241 and the second columnar conductor 221 corresponds to an example of “first internal conductor” described in the claims. The other of the extended conductor 241 and the second columnar conductor 221 corresponds to an example of “second internal conductor” described in the claims. In this case, the second via conductor 222 corresponds to an example of “via conductor” described in the claims.

One of the first inductor conductor 100A and the second inductor conductor 100B corresponds to an example of “first internal conductor” described in the claims. The other of the first inductor conductor 100A and the second inductor conductor 100B corresponds to an example of “second internal conductor” described in the claims. In this case, the first interlayer via conductor 251 corresponds to an example of “via conductor” described in the claims.

FIG. 6 illustrate sections of four via conductors in the section including the central axis AX. However, it is sufficient that at least one of the four via conductors satisfy the aforementioned configurations illustrated in FIG. 3. The aforementioned configurations illustrated in FIG. 3 may be satisfied, but need not be satisfied, in another section including the central axis AX of the inductor component 1B. It is sufficient that least one of a plurality of via conductors included in the inductor component 1B satisfy the aforementioned configurations illustrated in FIG. 3.

### Fourth Embodiment

Configuration

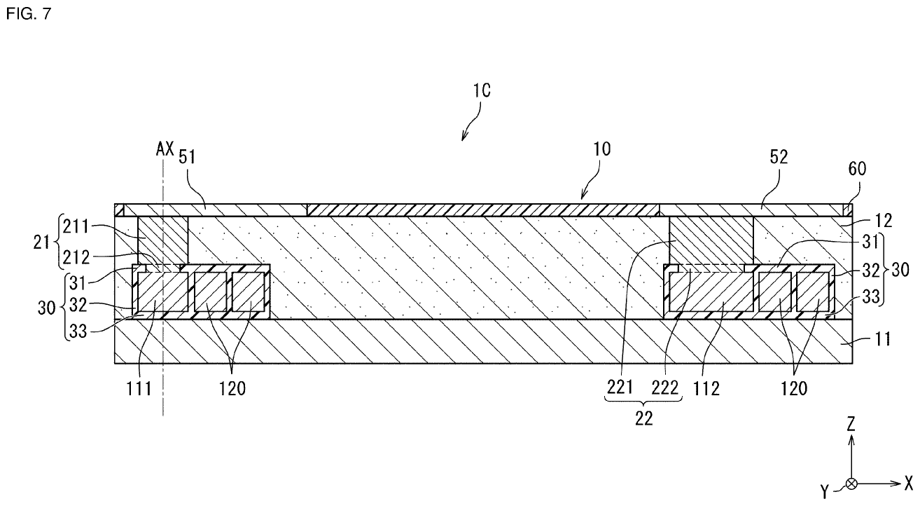

FIG. 7 is a schematic sectional view of an inductor component according to a fourth embodiment. FIG. 7 is a sectional view corresponding to FIG. 2. The fourth embodiment differs from the first embodiment in the configuration of the element body. The difference in configuration will be described below. The other elements of the fourth embodiment each have the same configuration as that of the first embodiment, and such elements will be denoted by the same numerals as in the first embodiment and descriptions thereof will be omitted.

As illustrated in FIG. 7, the element body 10 has a first magnetic layer 11 and a second magnetic layer 12 disposed on the first magnetic layer 11. The first magnetic layer 11 and the second magnetic layer 12 are stacked in the central axis AX direction so that the inductor conductor 100 and the insulating layer 30 are interposed therebetween. The element body 10 has a two-layer structure of the first magnetic layer 11 and the second magnetic layer 12. However, the element body 10 may have a three-layer structure of the first magnetic layer 11, a substrate, and the second magnetic layer 12.

The first magnetic layer 11 and the second magnetic layer 12 each have a resin and a magnetic metal powder as a magnetic substance included in the resin. Accordingly, compared with a magnetic layer made of ferrite, the magnetic metal powder can improve the direct current superposition characteristics, and the resin can reduce a loss (iron loss) at high frequencies because the resin insulates the particles of the magnetic metal powder from each other.

The resin includes, for example, any of an epoxy resin, a polyimide resin, a phenolic resin, and a vinyl ether resin. Thus, insulation reliability is improved. To be more specific, the resin is an epoxy resin, a mixture of an epoxy resin and an acrylic resin, or a mixture of an epoxy resin, an acrylic resin, and another resin. Thus, insulation between the particles of the magnetic metal powder is ensured, and a loss (iron loss) at high frequencies can be reduced.

The average particle diameter of the magnetic metal powder is, for example, 0.1 μm or greater and 5 μm or less (i.e., from 0.1 μm to 5 μm). In the process of manufacturing the inductor component 1, it is possible to calculate the average particle diameter of the magnetic metal powder as a particle diameter corresponding to a 50% cumulative value in a particle-diameter distribution obtained by using a laser diffraction scattering method. The magnetic metal powder is a powder of, for example, an FeSi-based alloy such as FeSiCr, a FeCo-based alloy, a Fe-based alloy such as NiFe, or an amorphous alloy of any of these. Preferably, the magnetic metal powder content in the entirety of the magnetic layer is 20 vol % or more and 70 vol % or less (i.e., from 20 vol % to 70 vol %). When the average particle diameter of the magnetic metal powder is 5 μm or less, the direct current superposition characteristics are improved further, and the iron loss at high frequencies can be reduced due to the fine powder. When the average particle diameter of the magnetic metal powder is 0.1 μm or greater, it is easy to disperse the powder evenly in the resin, and the efficiency in manufacturing the first magnetic layer 11 and the second magnetic layer 12 is improved. Instead of the magnetic metal powder or in addition to the magnetic metal powder, a ferrite magnetic powder of NiZn-based ferrite, MnZn-based ferrite, or the like may be used.

### EXAMPLES

### Example 1

Following the manufacturing method illustrated in FIGS. 4A to 4K, thirty inductor components 1A each having a configuration according to the second embodiment were produced. In the steps illustrated in FIGS. 4F and 4G, the via 31Z was formed by using a lithographic method. The width of the via 31Z on the second main surface 31Y was 100 μm, and the length of the via 31Z in the central axis AX direction (the height, or the thickness of the insulating interlayer 31) was 15 μm. In the step illustrated in FIG. 4F, wet etching was performed at 25° C. by using a processing agent including H₂O₂ at a 5% concentration and H₃PO₄ at a 10% concentration. The etching processing time was adjusted so that the width W of the wedge portion 212a became 2.0 μm.

### Example 2

Except that the etching processing time was adjusted so that the width W of the wedge portion 212a became 2.5 μm, thirty inductor components 1A were produced in the same way as in Example 1.

### Example 3

Except that the etching processing time was adjusted so that the width W of the wedge portion 212a became 3.0 μm, thirty inductor components 1A were produced in the same way as in Example 1.

### Example 4

Except that the etching processing time was adjusted so that the width W of the wedge portion 212a became 4.0 μm, thirty inductor components 1A were produced in the same way as in Example 1.

### Example 5

Except that the etching processing time was adjusted so that the width W of the wedge portion 212a became 9.0 μm, thirty inductor components 1A were produced in the same way as in Example 1.

### Example 6

Except that the etching processing time was adjusted so that the width W of the wedge portion 212a became 10.0 μm, thirty inductor components 1A were produced in the same way as in Example 1.

### Example 7

Except that the etching processing time was adjusted so that the width W of the wedge portion 212a became 10.5 μm, thirty inductor components 1A were produced in the same way as in Example 1.

### Example 8

Except that the etching processing time was adjusted so that the width W of the wedge portion 212a became 11.0 μm, thirty inductor components 1A were produced in the same way as in Example 1.

Evaluation

A connection reliability test was performed on each of the obtained inductor components 1A in accordance with JIS C60062-2-58. The inductor components 1A whose resistance-value change ratio was 20% or less were classified as acceptable products, and the inductor components 1A whose resistance-value change ratio was more than 20% and that had a crack in the via conductor were classified as unacceptable products. In order to exclude products whose resistance-value change ratio exceeded 20% due to a cause other than a crack, the inductor components 1A whose resistance-value change ratio was more than 20% and that did not have a crack in the via conductor were not evaluated. Evaluation was performed until the total number of acceptable products and unacceptable products became 30. Table 1 shows the number of acceptable products for the total number of evaluations (30).

TABLE 1

| | Examples | | | | | | | |
|---|---|---|---|---|---|---|---|---|
| | 1 | 2 | 3 | 4 | 5 | 6 | 7 | 8 |
| Width W (μm) | 2.0 | 2.5 | 3.0 | 4.0 | 9.0 | 10.0 | 10.5 | 11.0 |
| Number of | 28/30 | 29/30 | 30/30 | 30/30 | 30/30 | 30/30 | 29/30 | 27/30 |
| Acceptable | | | | | | | | |
| Products | | | | | | | | |

It can be understood that each of the inductor components 1A provided with the wedge portion 212a had high connection reliability. Regarding Examples 3 to 6, in which the width W of the wedge portion 212a was 3 μm or greater and 10 μm or less (i.e., from 3 μm to 10 μm), connection reliability was particularly high.

The present disclosure is not limited to the embodiments described above, and may be modified within the gist of the present disclosure.

In the embodiments described above, the first via conductor 212 is symmetrical about the central axis AX in the first section. However, the first via conductor 212 may be unsymmetrical about the central axis AX. The first via conductor 212 has the wedge portion 212a on both sides of the central axis AX. However, the wedge portion 212a may be present on only one side.

In the embodiments described above, the first via conductor 212 has a rectangular shape in a see-through plan view of the inductor component. However, this is not a limitation. The first via conductor 212 may have a circular shape, an elliptical shape, or a polygonal shape in the plan view.

In the embodiments described above, the second via conductor 222 has a circular shape in a see-through plan view of the inductor component. However, this is not a limitation. The second via conductor 222 may have a circular shape, an elliptical shape, or a polygonal shape in the plan view.

In the embodiments described above, the wedge portion 212a is formed by etching the first pad portion 111. However, the wedge portion 212a may be formed by etching a part, on the first pad portion 111 side, of the end portion of the insulating interlayer 31 on the via 31Z side.

In the embodiments described above, the first via conductor 212 has the protruding portion 212b. However, the first via conductor 212 need not have the protruding portion 212b.

In the embodiments described above, the first pad portion 111 has the recessed portion 111a. However, the first pad portion 111 need not have the recessed portion 111a.

In the embodiments described above, the inner surface of the via 31Z extends in the direction along the central axis AX. However, the inner surface of the via 31Z may be inclined so that, from the first pad portion 111 toward the first columnar conductor 211, the width of the via 31Z increases or so that the width of the via 31Z decreases. The flat inner surface of the via 31Z may be inclined with respect to the central axis AX as long as the flat inner surface is illustrated to be a straight line in the first section.

In the embodiments described above, the insulating interlayer 31 and the resin wall 32 are integrally formed. However, this is not a limitation. The insulating interlayer 31 and the resin wall 32 may be independent from each other, and may be formed in different steps.

In the third embodiment, the inductor conductors 100A and 100B in two layers are stacked in the central axis AX direction. However, inductor conductors in three or more layers may be stacked in the central axis AX direction. A plurality of inductor conductors may be arranged in a direction perpendicular to the central axis AX direction.

The present disclosure includes the following aspects.

<1> An inductor component comprising a first internal conductor; a second internal conductor; an insulating interlayer disposed between the first internal conductor and the second internal conductor and having a first main surface on the first internal conductor side, a second main surface on the second internal conductor side, and a via extending therethrough between the first main surface and the second main surface; and a via conductor inserted through the via and electrically connecting the first internal conductor and the second internal conductor. In a first section including a central axis of the via conductor, the via conductor has a wedge portion interposed between the insulating interlayer and the first internal conductor in a direction parallel to the central axis.

<2> The inductor component described in <1>, wherein, in the first section, the via has a flat inner surface, the inner surface includes a first open end on the first internal conductor side and a second open end on the second internal conductor side. Also, when a first reference line is defined as a straight line including the first open end and parallel to the central axis, the wedge portion is located on a side opposite to the central axis with respect to the first reference line, and a distance from an intersection point of the first internal conductor and the insulating interlayer to the first open end in a direction perpendicular to the central axis is 3 μm or greater and 10 μm or less (i.e., from 3 μm to 10 μm).

<3> The inductor component described in <1> or <2>, wherein, in the first section, the first main surface includes a first portion in contact with the first internal conductor. Also, when a second reference line is defined as a straight line including the first portion, the first internal conductor has a recessed portion recessed from the second reference line, and the via conductor has a protruding portion protruding into the recessed portion.

<4> The inductor component described in any one of <1> to <3>, wherein, in the first section, the via has a flat inner surface, the inner surface includes a first open end on the first internal conductor side and a second open end on the second internal conductor side, the first main surface includes a first portion in contact with the first internal conductor, the insulating interlayer has a connection portion between the first open end of the inner surface and an end portion of the first portion on the first open end side, and the connection portion includes a convexly curved surface.

<5> The inductor component described in any one of <1> to <4>, further comprising an element body, wherein the first internal conductor and the second internal conductor are provided in the element body, and at least one of the first internal conductor and the second internal conductor is an inductor conductor.

<6> The inductor component described in <5>, wherein both of the first internal conductor and the second internal conductor are inductor conductors.

<7> The inductor component described in <5> or <6>, wherein the element body includes a magnetic layer.

<8> The inductor component described in <5> or <6>, wherein the element body includes a non-magnetic insulating layer.

What is claimed is:

1. An inductor component comprising:
a first internal conductor;
a second internal conductor;
an insulating interlayer between the first internal conductor and the second internal conductor and having a first main surface on the first internal conductor side, a second main surface on the second internal conductor side, and a via extending therethrough between the first main surface and the second main surface; and
a via conductor inserted through the via and electrically connecting the first internal conductor and the second internal conductor,
wherein, in a first section including a central axis of the via conductor, the via conductor has a wedge portion interposed between the insulating interlayer and the first internal conductor in a direction parallel to the central axis.

2. The inductor component according to claim 1, wherein
in the first section,
the via has a flat inner surface,
the inner surface includes a first open end on the first internal conductor side and a second open end on the second internal conductor side, and
when a first reference line is defined as a straight line including the first open end and parallel to the central axis,
the wedge portion is on a side opposite to the central axis with respect to the first reference line, and
a distance from an intersection point of the first internal conductor and the insulating interlayer to the first open end in a direction perpendicular to the central axis is from 3 μm to 10 μm.

3. The inductor component according to claim 1, wherein
in the first section,
the first main surface includes a first portion in contact with the first internal conductor, and
when a second reference line is defined as a straight line including the first portion,
the first internal conductor has a recessed portion recessed from the second reference line, and
the via conductor has a protruding portion protruding into the recessed portion.

4. The inductor component according to claim 1, wherein
in the first section,
the via has a flat inner surface,
the inner surface includes a first open end on the first internal conductor side and a second open end on the second internal conductor side,
the first main surface includes a first portion in contact with the first internal conductor,
the insulating interlayer has a connection portion between the first open end of the inner surface and an end portion of the first portion on the first open end side, and
the connection portion includes a convexly curved surface.

5. The inductor component according to claim 1, further comprising:
an element body,
wherein the first internal conductor and the second internal conductor are in the element body, and
wherein at least one of the first internal conductor and the second internal conductor is an inductor conductor.

6. The inductor component according to claim 5, wherein
both of the first internal conductor and the second internal conductor are inductor conductors.

7. The inductor component according to claim 5, wherein
the element body includes a magnetic layer.

8. The inductor component according to claim 5, wherein
the element body includes a non-magnetic insulating layer.

9. The inductor component according to claim 2, wherein
in the first section,
the first main surface includes a first portion in contact with the first internal conductor, and
when a second reference line is defined as a straight line including the first portion,
the first internal conductor has a recessed portion recessed from the second reference line, and
the via conductor has a protruding portion protruding into the recessed portion.

10. The inductor component according to claim 2, wherein
in the first section,
the via has a flat inner surface,
the inner surface includes a first open end on the first internal conductor side and a second open end on the second internal conductor side,
the first main surface includes a first portion in contact with the first internal conductor,
the insulating interlayer has a connection portion between the first open end of the inner surface and an end portion of the first portion on the first open end side, and
the connection portion includes a convexly curved surface.

11. The inductor component according to claim 2, further comprising:
an element body,
wherein the first internal conductor and the second internal conductor are in the element body, and
wherein at least one of the first internal conductor and the second internal conductor is an inductor conductor.
